(19) United States
(12) Patent Application Publication
(10) Pub. No.: US 2008/0088589 A1
(43) Pub. Date: Apr. 17, 2008

(54) SCANNING CIRCUIT AND METHOD FOR KEYBOARD

(75) Inventors: Shih-Fang Wong, Tu-Cheng (TW); De-Zhi Li, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,824

(22) Filed: Dec. 27, 2006

(30) Foreign Application Priority Data
Oct. 13, 2006 (CN) 200610063080.0

(51) Int. Cl. G09G 5/00

(52) U.S. Cl. 345/168

(57) ABSTRACT

A scanning circuit is provided for scanning keys of a keyboard. The scanning circuit includes n column wires C₁˜Cₙ (where n is a natural number), a ground row wire R0, n row wires R₁˜Rₙ, and n*n switches. The ground row wire R₀ is connected to ground. The n row wires R₁˜Rₙ and the ground row wire R₀ cooperate with the n column wires C₁˜Cₙ in forming a matrix comprising n*(n+1) intersections. The n*n switches are set on the matrix. A first contact of each switch is electrically connected to a corresponding row wire or the ground row wire, and a second contact of each switch is electrically connected to a corresponding column wire. The row wires are electrically connected to input ports P₁˜Pₙ respectively. An end of each column wire is electrically connected to a connection between an input port and a corresponding row wire. A scanning method is also disclosed.

### BACKGROUND OF THE INVENTION

1. Field of the Invention

The present invention generally relates to scanning circuits and scanning methods for keyboards, and particularly to a scanning circuit and a scanning method employing a switch matrix.

2. Description of Related Art

Traditionally, keyboards are widely used as input means for various electronic devices, such as computers, PDAs (personal digital assistances). Usually, each keyboard includes a plurality of keys capable of being pressed, and a scanning circuit with a row-column type structure. The row-column type structure, also called a switch matrix, is aligned with the keys. The scanning circuit includes a plurality of row wires and a plurality of column wires. The keys are set above intersections where the row wires cross the column wires. A plurality of switches is deposited at the intersections, with two contacts of each switch being electrically connected to one row wire and one column wire respectively. Therefore, when the key is pressed, the corresponding switch is closed. The row wire and the column wire corresponding to this switch are then electrically connected. When the scanning circuit scans, the column wires are set to either high or low, and the row wires are then used as outputs. As a result, which switch is closed can be determined.

Referring to FIG. 4, a conventional scanning circuit 101 is used in a keyboard (not shown) including sixteen keys. The sixteen keys are capable of being pressed. The scanning circuit 101 includes four row wires R₁˜R₄ and four column wires C₁˜C₄, the row wires and the column wires form a switch matrix (not labeled) including sixteen intersections. Sixteen switches C₁R₁˜C₄R₄ are set at the intersections respectively, with two contacts of each switch electrically connected to a corresponding row wire and a corresponding column wire respectively, e.g., one contact of a switch C₁R₁ is electrically connected to a row wire R₁ and the other contact of the switch C₁R₁ is electrically connected to a column wire C₁. Each of the sixteen switches is normally open until a key is pressed and then the corresponding switch closes. For example, when a key is pressed, a corresponding switch, such as C₁R₁, closes, then the row wire R₁ and the column wire C₁ are electrically connected. When the key is released, the corresponding switch opens. Furthermore, four input ports P₁˜P₄ are electrically connected to ends of the column wires C₁˜C₄ respectively, and four output ports P₅˜P₈ are electrically connected to the row wires R₁˜R₄ respectively. A power source is electrically connected to the other end of each column wire via a resistor.

During scanning, each input port P₁˜P₄ is sequentially set low. When one of the input ports P₁˜P₄ is set low, the rest of the input ports P₁˜P₄ are set high. The output ports are checked to find out if any switches are closed. Therefore, pressed keys, which correspond to the switches can be identified.

As an example, if the input port P₁ electrically connected to the column wire C₁ is set low, the output port P₅ electrically connected to the row wire R₁ is also low, then the switch C₁R₁ is determined to be closed. Consequently, a pressed key corresponding to the switch C₁R₁, can be determined.

In practice, the input ports and the output ports are generally provided by a single-chip microprocessor. However, providing a microprocessor with so many ports consumes too much space.

Therefore, a scanning circuit and a scanning method capable of using fewer ports are needed in the industry to address the aforementioned deficiencies and inadequacies.

### SUMMARY OF THE INVENTION

A scanning circuit is provided for scanning keys of a keyboard. The scanning circuit includes n column wires C₁˜Cₙ (where n is a natural number), a ground row wire R₀, n row wires R₁˜Rₙ, and n*n switches. The ground row wire R₀ is connected to ground. The n row wires R₁˜Rₙ and the ground row wire R0 cooperate with the n column wires C₁˜Cₙ in forming a matrix comprising n*(n+1) intersections. The n*n switches are set on the matrix. A first contact of each switch is electrically connected to a corresponding row wire, and a second contact of each switch is electrically connected to a corresponding column wire. The row wires are electrically connected to input ports P₁˜Pₙ respectively. An end of each column wire is electrically connected to a connection between an input port and a corresponding row wire. A scanning method is also disclosed.

Other systems, methods, features, and advantages of the present variable scanning circuit and a scanning method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present scanning circuit and the present scanning method can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is a schematic diagram of a scanning circuit in accordance with an exemplary embodiment;

FIG. 2 is a truth table for the input ports of FIG. 1;

FIG. 3 is a flowchart of a scanning method in accordance with an exemplary embodiment; and

FIG. 4 is a schematic diagram showing a conventional scanning circuit.

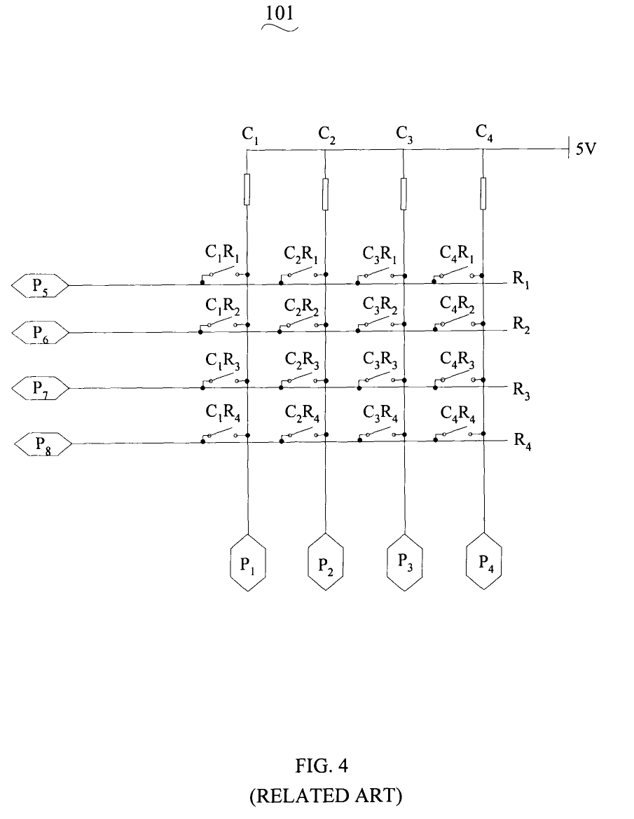

### DETAILED DESCRIPTION OF THE INVENTION

Reference will now be made to the drawings to describe a preferred embodiment of the present scanning circuit and a preferred embodiment of the present scanning method.

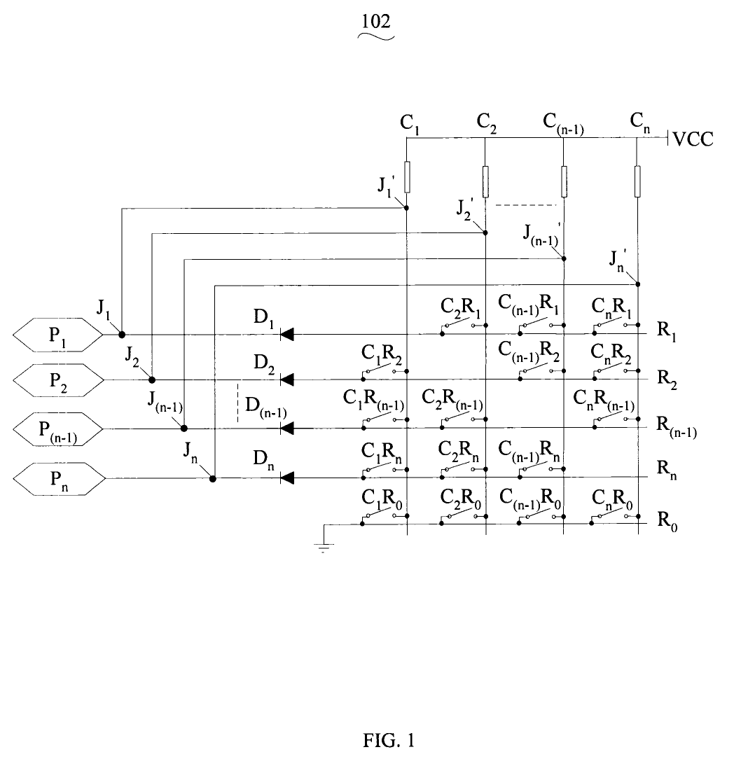

Referring to FIG. 1, a scanning circuit 102 in accordance with an exemplary embodiment is illustrated. The scanning circuit 102 includes (n+1) row wires and n column wires, wherein n is a natural number. The row wires R₀˜Rₙ, and the column wires C₁˜Cₙ, form a switch matrix (not labeled), which includes n*(n+1) intersections. The scanning circuit 102 further includes n*n switches C₁R₀˜CₙR(ₙ₋₁₎ deposited at the intersections. Each switch has two contacts, e.g. a first contact and a second contact. The first contact is electrically connected to a corresponding row wire, and a second contact is electrically connected to a corresponding column wire.

Regarding the row wires, the row wire R₀ is connected to ground, and includes switches S₀₁˜S₀ₙ for connecting to column wires C₁˜Cₙ. The other row wires R₁˜Rₙ are electrically connected to n input ports P₁˜Pₙ respectively. Each one of the other row wires R₁˜Rₙ includes a row node, a diode, and (n−1) switches, with their first contacts electrically connected to the one row wire. Take the row wire Rₙ as an example, a row node Jₙ is electrically connected between the input port Pₙ and a negative end of a diode Dₙ, and a positive end of the diode Dₙ is electrically connected to the first contacts of the (n−1) switches C₁Rₙ˜C₍ₙ₋₁₎Rₙ. Herein, the input ports P₁˜Pₙ are I/O ports of a single-chip microprocessor (not shown). Each one of the input ports P₁˜Pₙ is used for sequentially being set to low by the single-chip microprocessor.

Regarding the column wires, the column wires C₁˜Cₙ are electrically connected to a power supply VCC. Each one of the column wires C₁˜Cₙ includes a resistor, a column node, and n switches, with their second contacts electrically connected to the one column wire. Take the column wire Cₙ as an example, a resistor is electrically connected between the power supply VCC and a column node Jₙ′, and the column node Jₙ′ is electrically connected to the second contacts of the n switches CₙR₀˜CₙR₍ₙ₋₁₎.

Regarding the row wires R₁˜Rₙ and the column wires C₁˜Cₙ, each row wire is electrically connected to a correspondingly numbered column wire by connecting a row node and a column node together, e.g., the row wire Rₙ is electrically connected to the column wire Cₙ by connecting the row node Jₙ and the column node Jₙ′ together. An end of each column wire is electrically connected to nodes formed by the connections between the ports and the row wires.

In use, the input ports P₁˜Pₙ are normally high and the ground row wire R₀ is always low. First, it is determined if one of the switches is closed at the ground row wire R₀ by scanning the input ports P₁˜Pₙ. If any one of the input ports P₁˜Pₙ is low, then it is known a corresponding switch is closed.

Secondly, each one of the input ports P₁˜Pₙ is set to be low sequentially. That is, each one of the row wires R₁˜Rₙ is set to be low sequentially. When one of the input ports P₁˜Pₙ is set to be low, the other input ports are normally high. It is determined if one of the switches is closed at the one low wire by scanning the other ports. If any one of the other input ports P₁˜Pₙ is low, then it is known a corresponding switch is closed.

Therefore, n input ports are used, in the scanning circuit 102, to be checked to find out which one of the n*n switches is closed. In practice, a key corresponding to a closed switch must be pressed.

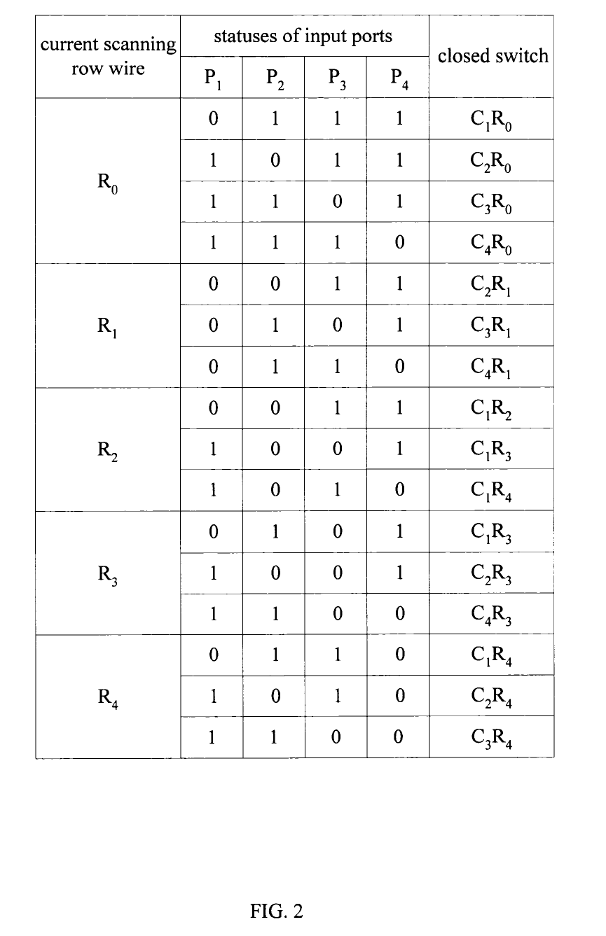

Referring also to FIG. 2, a truth table of the scanning circuit 102 wherein the natural number n equals 4 is shown. The truth table provides sixteen statuses of the input ports P₁, P₂, P₃, and P₄. Herein, some examples are taken to introduce the truth table. When the ground row wire R₀ is scanned, if the input ports P₁, P₂, P₃, and P₄ are found to be low, high, high, and high respectively, then the switch C₁R₀ is closed. When the row wire R₁ is scanned, if the input ports P₁, P₂, P₃, and P₄ are found to be low, low, high, and high respectively, then the switch C₂R₁ is closed.

Therefore, just four input ports P₁, P₂, P₃, and P₄ are needed for a scanning circuit with sixteen switches, which are easily provided by a single microprocessor. In practice, a key corresponding to a closed switch must be pressed.

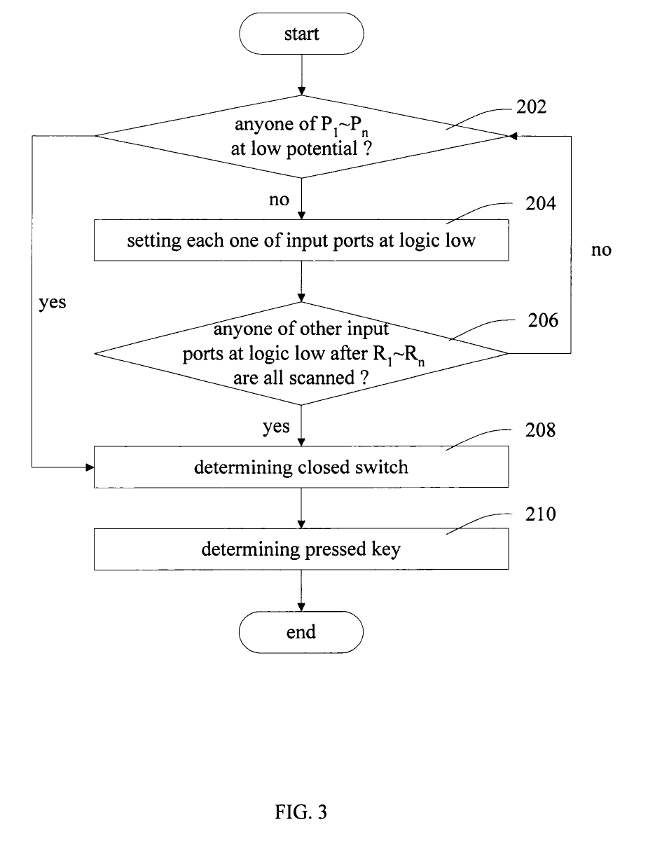

Referring to FIG. 3, a scanning method for scanning a keyboard to find out which keys thereof are pressed is illustrated, wherein the scanning method corresponds to the scanning circuit 102 mentioned above. The procedure includes the following steps.

Step 202, switches at the ground row wire R₀ are checked. The ground row wire R₀ is normally low, and the input ports P₁˜Pₙ are normally high. The input ports P₁˜Pₙ are directly scanned to find out whether any one of the input ports P₁˜Pₙ is low. If one of the input ports P₁˜Pₙ is low, the procedure goes to step 208.

Step 204, if none of input ports is low, switches at the row wires R₁˜Rₙ are checked in turn. That is, one of the input ports P₁˜Pₙ is set low.

Step 206, the rest of the input ports P₁˜Pₙ are scanned to find out if any one input port thereof is low.

After the input ports P₁˜Pₙ are sequentially set low, if one of the input ports P₁˜Pₙ is found to be low, the procedure goes to step 208, and if none of the input ports is found to be low, the procedure goes to step 202.

Step 208, it is determined that the switch corresponding to the two low input ports is closed.

Step 210, a key of the keyboard, corresponding to the closed switch, is identified.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. A scanning circuit for scanning a keyboard with a plurality of keys, the scanning circuit comprising:
a ground row wire R₀ connected to ground;
n row wires R₁˜Rₙ;
n input ports P₁˜Pₙ electrically connected to the row wires R₁˜Rₙ respectively;
n column wires C₁˜Cₙ cooperating with the ground row wire R₀ and the n row wires to form a matrix comprising n*(n+1) intersections;
n*n switches set on the matrix, and a first contact of each switch being electrically connected to a corresponding row wire, and a second contact of each switch being electrically connected to a corresponding column wire;
wherein an end of each column wire is electrically connected to a connection between one of the input ports P₁˜Pₙ and a corresponding row wire, and n is a natural number.

2. The scanning circuit according to claim 1, wherein the ground row wire R₀ is electrically connected to first contacts of n switches among the n*n switches, and second contacts of the n switches are electrically connected to the n column wires C₁˜Cₙ respectively.

3. The scanning circuit according to claim 2, wherein each one of the n row wires R₁˜Rₙ is electrically connected to first contacts of (n−1) switches among the n*n switches, and second contacts of the (n−1) switches are electrically connected to (n−1) column wires respectively.

4. The scanning circuit according to claim 3, wherein there is no switch connected between each column wire and its corresponding numbered row wire.

5. The scanning circuit according to claim 4, further comprising n diodes D₁˜Dₙ, wherein each one of the diodes D₁˜Dₙ is connected between a corresponding input port and (n−1) corresponding switches, with a positive end electrically connected to the (n−1) corresponding switches.

6. The scanning circuit according to claim 5, further comprising n first nodes J₁˜Jₙ, wherein each of the nodes J₁˜Jₙ is electrically connected between a corresponding input port and a corresponding diode.

7. The scanning circuit according to claim 6, further comprising a power supply, wherein the n column wires C₁˜Cₙ are electrically connected to the power supply.

8. The scanning circuit according to claim 7, wherein each of the n column wires is electrically connected to second contacts of n switches.

9. The scanning circuit according to claim 8, further comprising n second nodes J₁′˜Jₙ′, wherein each of the second nodes J₁′˜Jₙ′ is electrically connected to a corresponding numbered first node and the second contacts of the n switches.

10. The scanning circuit according to claim 9, further comprising n resistors, wherein each one of the resistors is electrically connected between the power supply and the second contacts of the n switches.

11. A scanning method comprising the steps of:
checking input ports P₁˜Pₙ to find out whether any one of the input ports thereof is low;
setting each one of the input ports P₁˜Pₙ to be low sequentially if none of the input ports is found to be low;
checking the other input ports P₁˜Pₙ to find out whether any one of the other input ports thereof is low;
determining which switch is closed if one of the other input ports is low according to a combination of the one input port and the other input port;
determining a pressed key according to which switch is determined to be closed.

12. The scanning method according to claim 11, further comprising a step of the procedure going to scanning a ground row wire R₀ if no low input port is found after having sequentially set each of the input ports P₁˜Pₙ low.

13. The scanning method according to claim 12, wherein the input ports P₁˜Pₙ are electrically connected to n row wires R₁˜Rₙ.
